(19) United States
(12) Patent Application Publication
(10) Pub. No.: US 2022/0180337 A1
(43) Pub. Date: Jun. 9, 2022

(54) SYSTEMS AND METHODS FOR CONFIGURING RECURRING DATA TRANSFERS

(71) Applicant: The Toronto-Dominion Bank, Toronto (CA)

(72) Inventors: Milos DUNJIC, Oakville (CA); David Samuel TAX, Toronto (CA)

(73) Assignee: The Toronto-Dominion Bank, Toronto (CA)

(21) Appl. No.: 17/112,093

(22) Filed: Dec. 4, 2020

(51) Int. Cl. G06Q 20/10; G06Q 20/38; G06Q 20/40

(52) U.S. Cl. CPC G06Q 20/102; G06Q 20/405; G06Q 20/385

(57) ABSTRACT

Methods and computer systems for configuring recurring data transfers. Receiving, from a first computing system, a request to configure a recurring data transfer to a recipient, the request provided as a request for an immediate data transfer, the request for the immediate data transfer indicating a requested transfer amount and an intended transferor, the intended transferor indicated using an alias. Receiving user input from a computing device engaged using the alias, the user input including an indication of authorization of the immediate data transfer, the indication further including an indication of consent to pre-authorization of the recurring data transfer. In response to receiving the user input, transmitting a message to a system associated with the recipient, the message transferring data indicating the requested transfer amount, and wherein the message further includes an indication to the system associated with the recipient of consent to pre-authorization of the recurring data transfer.

### FIELD

The present disclosure relates to electronic data transfer systems and, more particularly, to systems and methods for configuring recurring electronic data transfers.

### BACKGROUND

Recurring bills are often paid using a pre-authorized debit. For example, a payer may authorize a biller to debit the payer's bank account whenever a bill is due.

Setting up the pre-authorization of a debit traditionally requires the payer to send a void cheque to the biller in the mail. The biller and/or the biller's financial institution may have to electronically scan information on the void cheque in order to obtain the payer's bank account information and feed it into a computer system operated by the biller's financial institution. When a bill is due, the biller's financial institution can electronically debit the payer's bank account. The payer may access their financial institution's computer system to view debits made to their bank account.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2 shows a high-level schematic diagram of the remote device of FIG. 1;

FIG. 3 shows a simplified organization of software components stored in a memory of the remote device of FIG. 2;

FIG. 4 shows a high-level schematic diagram of an example embodiment of the source, target and overlay computing systems of FIG. 1;

FIG. 5 shows a simplified organization of software components stored in the example computing systems of FIG. 4;

FIG. 6 is a flowchart showing operations performed in configuring a recurring data transfer;

FIG. 7 is an example interface including a notification;

FIG. 8 is an example interface prompting for the selection of a logical storage area;

FIG. 9 is an example interface for selecting rule definitions; and

FIG. 10 is an example interface for providing consent to an immediate data transfer and consent to pre-authorization of a recurring data transfer.

Similar reference numerals may have been used in different figures to denote similar components.

### DETAILED DESCRIPTION OF EXAMPLE EMBODIMENTS

In one embodiment, the present application describes a computer system. The computer system may include a communications module; a processor coupled to the communications module; and a memory coupled to the processor. The memory may store instructions that, when executed by the computer system, cause the computer system to: receive, from a first computing system, a request to configure a recurring data transfer to a recipient, the request provided as a request for an immediate data transfer, the request for the immediate data transfer indicating a requested transfer amount and an intended transferor, the intended transferor indicated using an alias; receive user input from a computing device engaged using the alias, the user input including an indication of authorization of the immediate data transfer from a logical storage area associated with the intended transferor, the indication further including an indication of consent to pre-authorization of the recurring data transfer from the logical storage area associated with the intended transferor; and in response to receiving the user input, transmit a message to a system associated with the recipient, the message transferring data indicating the requested transfer amount from the logical storage area associated with the intended transferor, and wherein the message further includes an indication to the system associated with the recipient of consent to pre-authorization of the recurring data transfer.

In this way, by transferring data indicating the requested transfer amount in response to the request for the immediate data transfer, the target system validates that the target and source systems are configured to process the recurring data transfer. Conveniently, this may avoid errors that may arise in traditional computing systems that do not validate that the payer's banking information is correctly entered into the computing systems operated by the biller's financial institution and only discover an error at the time a debit is made. Validating the configuration through an immediate data transfer may avoid the related usage of computing resources in creating, identifying and reversing errors that may otherwise arise. Additionally or alternatively, the configuration may be more secure than in earlier computing systems that might not require any user input from the transferor that indicates authorization. Additionally or alternatively, configuring the recurring data transfer in this way may be more efficient than setting up a pre-authorized transfer in other manners such as, for example, by a void cheque. For example, the biller and their financial institution may avoid scanning the void cheque to feed the payer's banking information into a computer system operated by the biller's financial institution. Additionally or alternatively, the user interface provided by the source system may be made more intuitive than in earlier system that allow a transferor to view debits made to their bank account but do not facilitate configuring a recurring data transfer and providing consent to pre-authorize a recurring data transfer. In other words, the source system may provide an improved user interface for managing recurring data transfers.

In some implementations, the instructions may further cause the computer system to configure a data transfer to occur on a date specified in metadata included in the request to configure the recurring data transfer and for a recurring transfer amount specified in the metadata.

In some implementations, the requested transfer amount may be different from the recurring transfer amount.

In some implementations, the instructions may further cause the computer system to, in response to receiving the user input from the computing device, transmit, to the system associated with the recipient, a logical storage area identifier to be used to conduct the recurring data transfer.

In some implementations, the instructions may further cause the computer system to receive user input from the computing device indicating rule definitions; transmit the rule definitions to the system associated with the recipient; and enforce the rule definitions.

In some implementations, the first computing system may map the alias to a financial institution.

In some implementations, the request to configure the recurring data transfer may be received in response to user activation of an email or text message that prompts the computer system to retrieve the request for the immediate data transfer from the first computing system.

In some implementations, the instructions may further cause the computer system to receive, on the date specified in the metadata, a request to transfer data, the request to transfer data indicating an overage transfer amount associated with an actual usage amount exceeding an expected usage amount.

In some implementations, the requested transfer amount is nominal or zero.

In some implementations, the indication of authorization of the immediate data transfer from the logical storage area associated with the intended transferor further may include an indication of authorization of the immediate data transfer from the logical storage area associated with the intended transferor to a logical storage area associated with the recipient.

In another aspect, present application describes a method. The method may include receiving, via a communications module and from a first computing system, a request to configure a recurring data transfer to a recipient, the request provided as a request for an immediate data transfer, the request for the immediate data transfer indicating a requested transfer amount and an intended transferor, the intended transferor indicated using an alias; receiving, via the communications module, user input from a computing device engaged using the alias, the user input including an indication of authorization of the immediate data transfer from a logical storage area associated with the intended transferor, the indication further including an indication of consent to pre-authorization of the recurring data transfer from the logical storage area associated with the intended transferor; and in response to receiving the user input, transmitting a message to a system associated with the recipient, the message transferring data indicating the requested transfer amount from the logical storage area associated with the intended transferor, and wherein the message further includes an indication to the system associated with the recipient of consent to pre-authorization of the recurring data transfer.

In some implementations, the method may further include configuring a data transfer to occur on a date specified in metadata included in the request to configure the recurring data transfer and for a recurring transfer amount specified in the metadata.

In some implementations, the method may further include, in response to receiving the user input from the computing device, transmitting, to the system associated with the recipient, a logical storage area identifier to be used to conduct the recurring data transfer.

In some implementations, the method my further include receiving user input from the computing device indicating rule definitions; transmitting the rule definitions to the system associated with the recipient; and enforcing the rule definitions.

In some implementations, the method my further include receiving, on the date specified in the metadata, a request to transfer data, the request to transfer data indicating an overage transfer amount associated with an actual usage amount exceeding an expected usage amount.

In yet another aspect, present application describes a non-transitory computer-readable storage medium comprising processor-executable instructions which, when executed, configure a processor to: receive, from a first computing system, a request to configure a recurring data transfer to a recipient, the request provided as a request for an immediate data transfer, the request for the immediate data transfer indicating a requested transfer amount and an intended transferor, the intended transferor indicated using an alias; receive user input from a computing device engaged using the alias, the user input including an indication of authorization of the immediate data transfer from a logical storage area associated with the intended transferor, the indication further including an indication of consent to pre-authorization of the recurring data transfer from the logical storage area associated with the intended transferor; and in response to receiving the user input, transmit a message to a system associated with the recipient, the message transferring data indicating the requested transfer amount from the logical storage area associated with the intended transferor, and wherein the message further includes an indication to the system associated with the recipient of consent to pre-authorization of the recurring data transfer.

In yet another aspect, the present application discloses a non-transitory, computer-readable medium storing processor-executable instructions that, when executed by one or more processors, are to cause the one or more processors to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any subcombination, or all of the elements, without necessarily excluding any additional elements, and without necessarily requiring all of the elements.

Example embodiments of the present application are not limited to any particular operating system, system architecture, mobile device architecture, server architecture, or computer programming language.

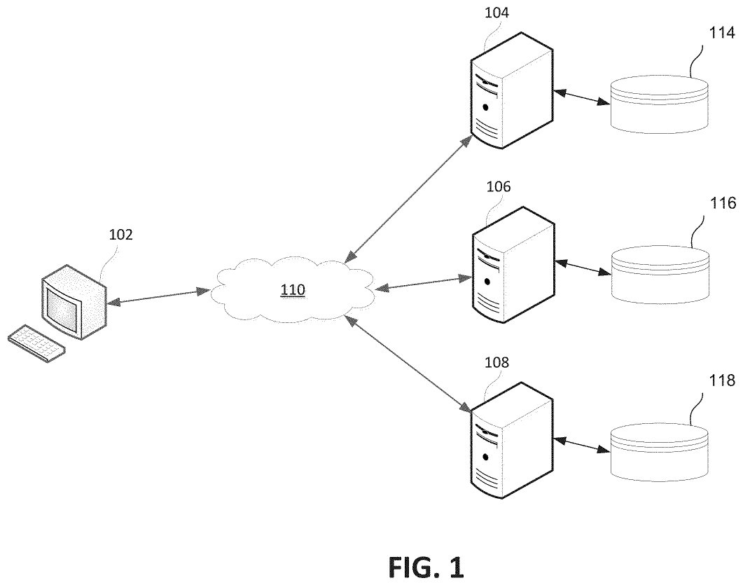

FIG. 1 shows a schematic diagram illustrating an operating environment of an example embodiment. The operating environment in this example includes a remote device 102, a source system 104, a target system 106, and an overlay system 108.

As illustrated, the source system 104 may provide a front-end interface which allows the remote device 102 to interact with the source system 104. For example, the source system 104 may provide one or more graphical user interfaces (GUIs) to the remote device 102. By way of example, the source system 104 may provide, to the remote device 102, a user interface. The user interface may be an interface for configuring and authorizing a recurring data transfer from the source system 104 to the target system 106. That is, the user interface, when displayed on the remote device 102, provides a selectable option to indicate consent to pre-authorization of the recurring data transfer from the source system 104 to the target system 106 via the network 110.

The source system 104 may be managed, operated, or controlled by an entity that is responsible for receiving the request to configure a recurring data transfer and for receiving user input from the remote device 102 for consenting to the request. The entity may be an agent of a transferor and may be a financial institution, such as a bank. The transferor may be a customer (e.g. a corporate/business customer) or client of the entity or otherwise associated with the entity.

The source system 104 may store data regarding one or more requests to configure a recurring data transfer in a plurality of respective configuration objects. A configuration object may be a data structure and may include details regarding a request for an immediate data transfer received and a request to configure a recurring data transfer to a recipient. Example details include identification information of the recipient, identification information of an entity associated with the recipient, a user account identifier of the recipient, a description of a service provided by the recipient, and an intended transferor, the intended transferor indicated using an alias. Example details regarding the request for the immediate data transfer include an invoice identifier and a requested transfer amount. Example details regarding the request to configure a recurring data transfer include an expected recurring transfer amount and a frequency of the recurring data transfer.

The configuration object may also include details regarding one or more rules for the recurring data transfer in a plurality of respective rule definitions. A rule definition may be defined for specifying handling actions for automatically processing data transfers from the source system 104 to the target system 106. Upon receiving a pre-authorized data transfer request from the target system 106, the source system 104 may access the corresponding configuration object to obtain rule definitions that are relevant to the data transfer request and determine a suitable handling action based on the rule definitions.

In some embodiments, the configuration object may be implemented as an ISO 20022 Request for Payment Message that represents a request for an immediate data transfer. The request for the immediate data transfer may include details regarding a request to configure a recurring data transfer and rule definitions.

The source system 104 may store data regarding users or customers associated with the source system 104 in a plurality of respective user account objects representing respective user accounts. A user account object may be a data structure and may include details regarding a user. Example details include a user account identifier, identification information (e.g. first and last name), an alias (e.g. email address, phone number), contact information (e.g. home address), sign in or authentication credentials (e.g. user name, password), and one or more identifiers that may link to one or more configuration objects. A user account may be associated with a logical storage area and a user account object may include one or more identifiers that may link to one or more logical storage areas.

The source system 104 may be used to transmit a message to a system associated with the recipient, for example, the target system 106. The message may transfer data indicating the requested transfer amount from a local storage area associated with the intended transferor to a local storage area associated with the recipient. The message may further include an indication to the system associated with the recipient of consent to pre-authorization of the recurring data transfer from the local storage area associated with the intended transferor to the local storage area associated with the recipient.

As illustrated, a target system 106 is in communication with the overlay system 108 and the source system 104 via the network 110. The target system 106 may be configured to transmit to the overlay system 108 a request to configure a recurring data transfer to a recipient. The target system 106 may be further configured to receive a message and the recurring data transfer from the source system 104.

The target system 106 may be managed, operated, or controlled by an entity that is responsible for receiving the recurring data transfer. The entity may be an agent of the recipient and may be a financial institution, such as a bank. The recipient may be a customer (e.g. a corporate/business customer) or client of the entity or otherwise associated with the entity.

The target system 106 may store data regarding one or more requests for data transfers in a plurality of respective configuration objects. The target system 106 may further store data regarding users or customers associated with the target system 106 in a plurality of respective user account objects representing respective user accounts.

The source system 104 may store the configuration objects and user account objects in a data store 114. A logical storage area that is associated with the transferor may be or include an area of the data store 114.

The target system 106 may store the configuration objects and user account objects in a data store 116. A logical storage area that is associated with the recipient may be or include an area of the data store 116.

A logical storage area may be or represent a bank account. Each of the data stores 114 and 116 may be a database of customer accounts and bank accounts at a particular financial institution.

The overlay system 108 may be configured to ingest data from the target system 106 and may transmit alerts, notifications, configuration objects, or other data to the remote device 102 and/or the source system 104. More particularly, the overlay system 108 may include infrastructure that receives a request from the target system 106, transmits a notification to the remote device and/or the source system 104 in response to receiving the request, and passes the request to the source system 104.

The overlay system 108 may store data regarding a mapping of an alias to the source system 104 and/or an entity associated with the source system 104 (e.g. a financial institution). For example, the alias may be mapped to an identifier of the source system 104 (e.g. a financial institution identifier). The mapping data may be stored in a data store 118.

As illustrated, the remote device 102 is in communication with a source system 104 via a network 110. The remote device 102 may be managed, operated or controlled by the transferor. The remote device 102 may be associated with an alias associated with the transferor and a user account associated with the transferor and the source system 104. The remote device 102 may be engaged using the alias.

The remote device 102 may be used, for example, to receive user input that includes an indication of authorization of an immediate data transfer from a logical storage area associated with the intended transferor to a logical storage area associated with the recipient. The indication may further include an indication of consent to pre-authorization of a recurring data transfer from the logical storage area associated with the intended transferor and to the logical storage area associated with the recipient.

The remote device 102 is a computing device. It may, as illustrated, be a desktop computer. However, the remote device 102 may be a computing device of another type such as, for example, a smart phone, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The source system 104, target system 106, and overlay system 108 are or include a computer system such as a computer server systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The remote device 102, source system 104, target system 106, and overlay system 108 may be in geographically disparate locations.

The network 110 is a computer network. The network 110 may be an internetwork such as may be formed of one or more interconnected computer networks. For example, such a network may be or may include an Ethernet network, an asynchronous transfer mode (ATM) network, a wireless network, or the like. In some implementations, the network 110 may be the Internet. The network 110 allows the remote device 102, source system 104, target system 106, and overlay system 108 to communicate with one another.

As further described below, the remote device 102, the source system 104, target system 106 and overlay system 108 may be configured with software to perform associated functions such as those described herein.

FIG. 1 illustrates the source system 104, target system 106, overlay system 108, and data stores 114, 116 and 118 as separate computing devices. However, these systems may not be separate physical systems. For example, the source system 104 and the overlay system 108 may be implemented on a common physical device. As another example, the target system 106 and the overlay system 108 may be implemented on a common physical device. As yet another example, two or more of the source system 104, target system 106, and overlay system 108 may be implemented in software associated with a common processor. As yet a further example, the data stores 114, 116 and 118 may be included in the source system 104, target system 106 and overlay system 108, respectively, or may be external to those systems.

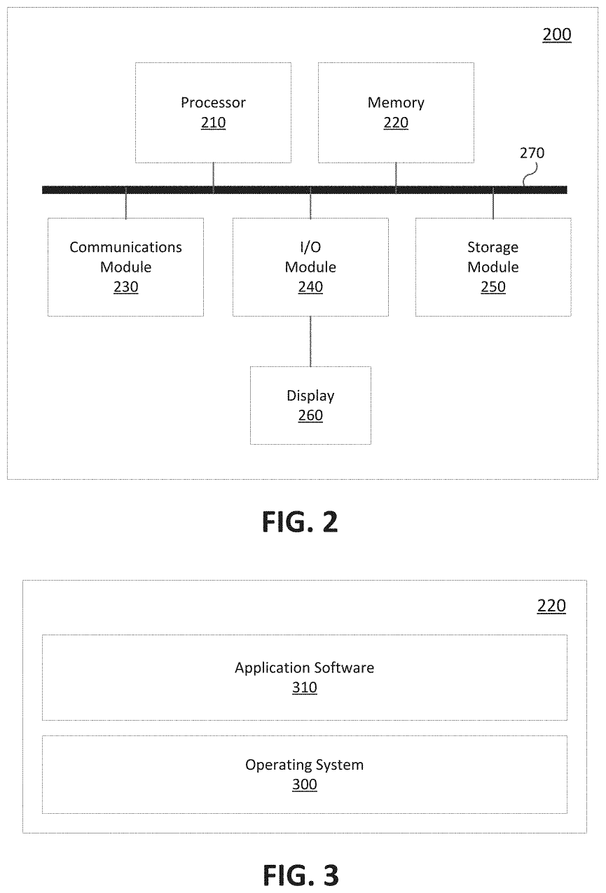

An example embodiment of the remote device 102 will now be discussed with reference to FIG. 2. FIG. 2 is a high-level schematic diagram of the remote device 100. The remote device 102 may, in some embodiments, be a personal computer as shown in FIG. 1.

The remote device 102 includes a variety of modules. For example, as illustrated, the remote device 102 may include a processor 210, a memory 220, a communications module 230, an I/O module 240, and/or a storage module 250. As illustrated, the foregoing example modules of the remote device 102 are in communication over a bus 370. As such, the bus 370 may be considered to couple the various modules of the remote device 102 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the remote device 102.

The communications module 230 allows the remote device 102 to communicate with other computing devices and/or various communications networks such as, for example, the network 110. For example, the communications module 230 may allow the remote device 102 to send or receive communications signals. Communications signals may be sent or received according to one or more protocols or according to one or more standards. The communications module 230 may allow the remote device 102 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 230 may allow the remote device 102 to communicate using near-field communication (NFC), via Wi-Fi™, using Bluetooth™ or via some combination of one or more networks or protocols. In some embodiments, all or a portion of the communications module 230 may be integrated into a component of the remote device 102. For example, the communications module 230 may be integrated into a communications chipset.

The I/O module 240 is an input/output module. The I/O module 240 allows the remote device 102 to receive input from and/or to provide input to components of the remote device 102 such as, for example, various input modules and output modules. For example, the I/O module 240 may, as shown, allow the remote device 102 to receive input from and/or provide output to the display 260.

The storage module 250 allows data to be stored and retrieved. In some embodiments, the storage module 250 may be formed as a part of the memory 220 and/or may be used to access all or a portion of the memory 220. Additionally or alternatively, the storage module 250 may be used to store and retrieve data from persisted storage other than the persisted storage (if any) accessible via the memory 220. In some embodiments, the storage module 250 may be used to store and retrieve data in/from a database. A database may be stored in persisted storage. Additionally or alternatively, the storage module 250 may access data stored remotely such as, for example, as may be accessed using a local area network (LAN), wide area network (WAN), personal area network (PAN), and/or a storage area network (SAN). In some embodiments, the storage module 250 may access data stored remotely using the communications module 230. In some embodiments, the storage module 250 may be omitted and its function may be performed by the memory 220 and/or by the processor 210 in concert with the communications module 230 such as, for example, if data is stored remotely.

The remote device 102 may include or be connected to a display 260. The display 260 is a module of the remote device 102. The display 260 is for presenting graphics. The display 260 may be, for example, a liquid crystal display (LCD). In addition to being an output device, the display 260 may also be an input device. For example, the display 260 may allow touch input to be provided to the remote device 102. In other words, the display 260 may be a touch sensitive display module. In a particular example, the display 260 may be a capacitive touch screen.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

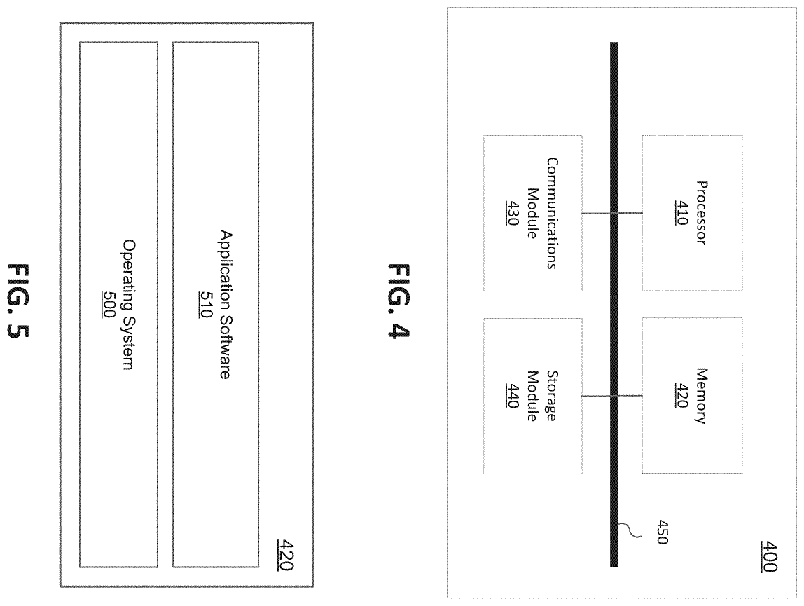

FIG. 3 depicts a simplified organization of software components stored in the memory 220 of the remote device 102. As illustrated, these software components include an operating system 300 and an application software 310.

The operating system 300 is software. The operating system 300 allows the application software 310 to access the processor 210 (FIG. 3), the memory 220, the communications module 230, the I/O module 240, and the storage module 250 of the remote device 100. The operating system 300 may be, for example, Google™ Android™, Apple™ iOS™, UNIX™, Linux™, Microsoft™ Windows™, Apple OSX™ or the like.

The application software 310 adapts the remote device 102, in combination with the operating system 300, to operate as a device for facilitating recurring data transfers.

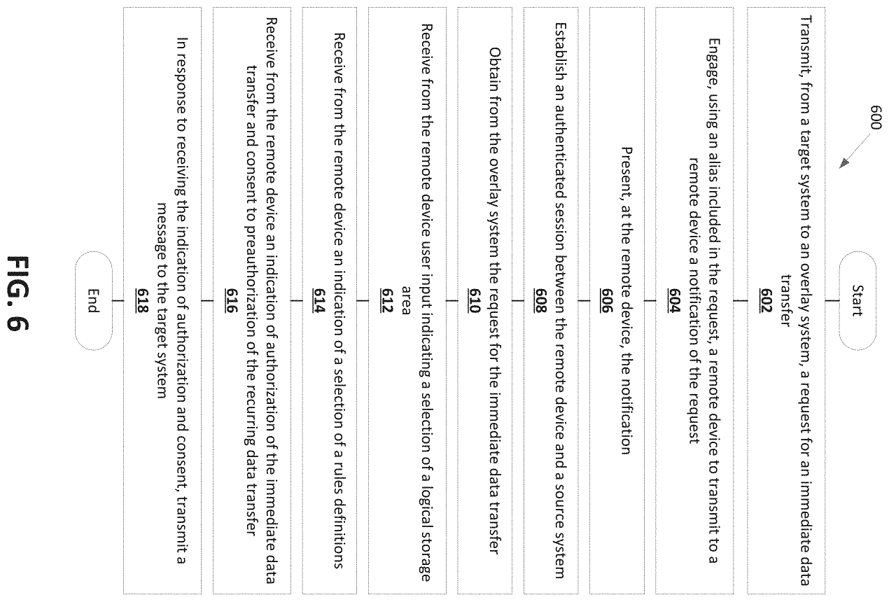

As noted above, the source system 104, target system 106, and overlay system 108 are or include a computer system. An example computer system 400 will now be discussed with reference to FIGS. 4 and 5. Suitably-configured instances of the example computer system 400 may, in some embodiments, serve as and/or be a part of the source system 104, target system 106, and/or overlay system 108.

FIG. 4 is a high-level schematic diagram of an example computer system 400.

The example computer system 400 includes a variety of modules. For example, as illustrated, the example computer system 400 may include a processor 410, a memory 420, a communications module 430, and/or a storage module 440. As illustrated, the foregoing example modules of the example computer system 400 are in communication over a bus 450. As such, the bus 450 may be considered to couple the various modules of the example computer system 400 to each other, including, for example, to the processor 410.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer system 400.

The communications module 430 allows the example computer system 400 to communicate with other computing devices and/or various communications networks such as, for example, the network 120. The communications module 430 may allow the example computer system 400 to send or receive communications signals. Communications signals may be sent or received according to one or more protocols or according to one or more standards. For example, the communications module 430 may allow the example computer system 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 430 may allow the example computer system 400 to communicate via Wi-Fi™, using Bluetooth™ or via some combination of one or more networks or protocols. In some embodiments, all or a portion of the communications module 430 may be integrated into a component of the example computer system 400. For example, the communications module may be integrated into a communications chipset.

The storage module 440 allows the example computer system 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persisted storage other than the persisted storage (if any) accessible via the memory 420. In some embodiments, the storage module 440 may be used to store and retrieve data in a database. A database may be stored in persisted storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access data stored remotely using the communications module 430. In some embodiments, the storage module 440 may be omitted and its function may be performed by the memory 420 and/or by the processor 410 in concert with the communications module 430 such as, for example, if data is stored remotely.

Software comprising instructions is executed by the processor 410 from a computer-readable medium. For example, software may be loaded into random-access memory from persistent storage of the memory 420. Additionally or alternatively, instructions may be executed by the processor 410 directly from read-only memory of the memory 420.

FIG. 5 depicts a simplified organization of software components stored in the memory 420 of the example computer system 400. As illustrated, these software components include an operating system 500 and an application software 510.

The operating system 500 is software. The operating system 500 allows the application software 510 to access the processor 410, the memory 420, the communications module 430, and the storage module 440 of the example computer system 400. The operating system 500 may be, for example, UNIX™, Linux™, Microsoft™ Windows™, Apple OSX™ or the like.

The application software 510, when executed, co-operates with the operating system 500 to adapt the example computer system 400 for some purpose and to provide some defined functionality. For example, the application software 510 may cooperate with the operating system 500 to adapt a suitable embodiment of the example computer system 400 to serve as the source system 104, target system 106, and/or overlay system 108.

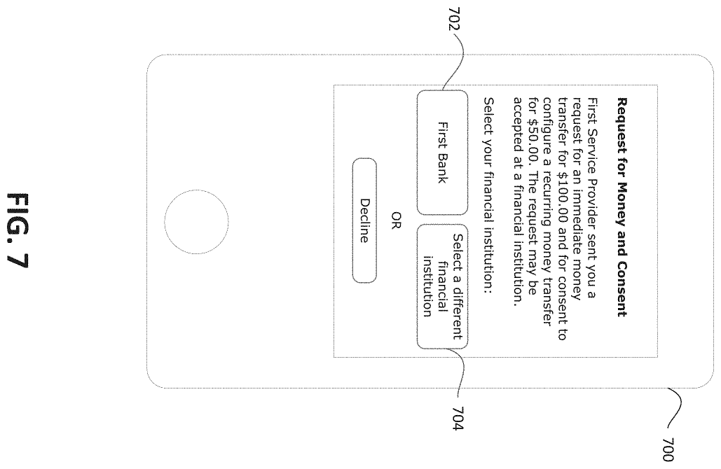

Reference will now be made to FIG. 6 which illustrates an example method 600. The operations of method 600 may be performed by a target system 106, an overlay system 108, and a source system 104 which may be of the type described herein. In particular, the operation 602 may be performed by the target system 106, the operation 604 may be performed by the overlay system 108, the operation 606 may be performed by the remote device 102, and the operations 608 to 612 may be performed by the source system 104.

In operation 602, the target system may transmit to the overlay system a request to configure a recurring data transfer to a recipient. The request may be provided as a request for an immediate data transfer. In some embodiments, the request is implemented as an ISO 20022 Request for Payment Message that represents a request for an immediate data transfer and includes as metadata a request to configure a recurring data transfer. In particular, the request may include, for example: a request identifier; identification information of the recipient (e.g. full name, address, contact details); identification information of an intended transferor (e.g. full name, address, contact details); an alias indicating the intended transferor; identification information of the target system and the entity associated with, operating or managing the target system (e.g. a financial institution identifier, routing number, branch transit number); identification information of a user account associated with the recipient (e.g. user account identifier); a requested transfer amount associated with the immediate data transfer; and a description of the requested transfer amount (e.g. account setup fee, enrollment or initiation fee, internet activation fee, modem purchase, utility connection fee, account transfer fee); identification information of a logical storage area (e.g. a logical storage area identifier) associated with, managed or controlled by the recipient to which the requested transfer amount and/or the expected recurring transfer amount is to be transferred to (e.g. bank account number); and an invoice identifier associated with the requested transfer amount. The metadata of the request may include, for example: an expected recurring transfer amount associated with the recurring data transfer; a description of the expected recurring transfer amount (e.g. Internet fees, phone fees, utility services, gym membership fees); and a frequency of the recurring data transfer (e.g. weekly, monthly, semi-monthly (1^{st} and 15^{th}), bi-weekly).

The requested transfer amount may be a substantial amount (e.g. more than a nominal amount), a nominal amount (e.g. one dollar, one cent), or zero (e.g. zero dollars). The requested transfer amount may be the same as from the expected recurring transfer amount or it may be different.

In operation 604, upon receiving the request transmitted by the target system, the overlay system may use the alias included in the request to engage a remote device. Engaging the remote device may involve using the alias to transmit a notification to the remote device, which is associated with the alias. The notification may include a request identifier or other indication of the request. In some embodiments, the notification may be an email or text message that prompts the source system to retrieve the request for the immediate data transfer from the overlay system.

In operation 606, upon receiving the notification, the remote device may present the notification to a user of the remote device via a user interface. The user interface may be that of a messaging application, such as an email application, text and/or voice message application, instant message application, or an application relating to the alias, an application relating to the source system, or an application for providing alerts. In some embodiments, the user interface may be a graphical user interface that presents the notification via pop-up, alert, or in any other suitable manner. The notification may include one or more, or a plurality of, selectable options associated with respective source systems. The notification may prompt for user input selecting an option.

The notification may be actionable, such as through a selectable link or other actionable user interface element, to either directly indicate a user selection or to navigate to a website, webpage, application interface, or other user interface through which the user is prompted to indicate a user selection. In some embodiments, the notification includes a link to navigate to a website or a webpage, hosted on the overlay system or the target system, through which the user is prompted to indicate a user selection.

In some embodiments, the user interface may provide one or more user selectable options for responding to the notification. The selectable options may be presented as a link, button or other actionable user interface element and may include text. The text may include the name of an entity associated with a source system.

The selection offered through the notification, website, webpage, and/or user interface may be to select an entity associated with, operating or managing a source system to be used to accept and process the request to configure the recurring data transfer. In particular, the selection offered may be to select a source system that includes a logical storage area associated with the transferor from which the requested transfer amount and the expected recurring transfer amount specified in the request are to be transferred from.

Referring briefly to FIG. 7, an example notification interface 700 is illustrated. The notification interface 700 includes first selectable option 702 for selecting an entity associated with a source system and launching an interface provided by the selected source system. For example, the first selectable option 702 may be displayed and used for identifying an entity associated with a source system. The first selectable option 702 may be activated in order to trigger the associated source system to process the request for an immediate data transfer and the request to configure a recurring data transfer.

The first selectable option 702 may be associated with a reference or uniform resource identifier (URI) that links to a specific source system. In other words, the first selectable option 702 may be a link for launching a user interface provided by a particular source system. For example, the first selectable option 702 may be invoked to launch an authentication interface for accepting user authentication.

When invoked, the first selectable option 702 may also pass to the source system associated with the URI a request identifier associated with the request to configure the recurring data transfer.

The notification interface 700 includes second selectable option 704 for selecting a different entity from that associated with the first selectable option 702. The second selectable option 704 may be associated with a reference or uniform resource identifier (URI) that links to a user interface provided by the overlay system 108. When invoked, the second selectable option 704 may also pass to the overlay system the request identifier.

For example, the second selectable option 704 may be invoked to launch a user interface that displays a list of selectable options for selecting an entity that is associated with, manages, or operates a source system from which the requested transfer amount and the expected recurring transfer amount are to be transferred from. The list of selectable options may be a list of links to respective authentication interfaces operated by respective financial institutions. For example, a link may be invoked to launch an authentication interface for accepting user authentication at a source system operated by the associated financial institution. When invoked, the link may also pass to the selected source system the request identifier.

The notification interface 700 may, in at least some embodiments, be provided to and received by the remote device 102 after the remote device 102 has successfully authenticated itself as being associated with the alias using a credential (e.g., username/password, biometric data, etc.). That is, the remote device uses a credential to confirm that it is associated with a particular alias. For example, when the alias is an email address, the remote device may authenticate itself with a third-party email server.

Referring back to FIG. 6, in operation 608, the source system may establish an authenticated session with the remote device. An authenticated session may include a session in which the identity of the user is verified by the source system through receiving and authenticating user account credentials. The user account credentials may include a user name and password combination, biometric information, or other credential data. In some embodiments, establishing an authenticated session may involve the source system providing to the remote device an authentication interface that prompts the user to sign in to the source system with credentials. The source system may receive credentials via the authentication user interface to establish an authenticated session with the remote device. In some embodiments, the remote device may authenticate itself as being associated with a user account that is associated with the transferor and the source system by providing a credential to the source system via an authentication interface launched through the notification interface.

In operation 610, the source system obtains from the overlay system the request for the immediate data transfer. The request may be obtained by providing to the overlay system the request identifier received by the source system from the remote device. In response, the overlay system may forward to the source system the particular request that is associated with the request identifier.

In this way, the request to configure the recurring data transfer may be received by the source system in response to user activation of an email or text message that prompts the source system to retrieve the request for the immediate data transfer from the overlay system.

In operation 612, upon obtaining the request for the immediate data transfer, the source system may provide to the remote device a user interface for prompting a user to select a logical storage area from which to make the immediate data transfer and the recurring data transfer. In response, the source system may receive from the remote device user input indicating a selection of a logical storage area that is associated with the source system, the authenticated user account, and is also controlled by, managed by, or otherwise associated with the intended transferor. The selection indicates the logical storage area from which the requested transfer amount and the recurring transfer amount are to be transferred from.

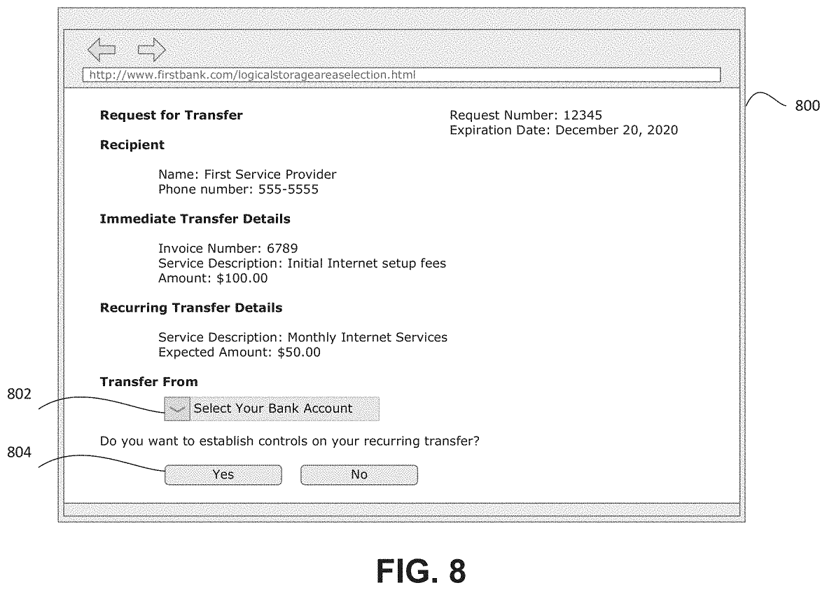

Referring briefly to FIG. 8, an example logical storage area selection interface 800 is illustrated. The logical storage area selection interface 800 includes a first selectable option 802 for selecting a logical storage area from which the immediate and recurring data transfers are to occur. In this example, the first selectable option 802 provides a dropdown list for selecting a bank account. The dropdown list may, for example, include an option for selecting a savings account and an option for selecting a chequing account. As illustrated, the logical storage area selection interface 800 may also display various details from the request for the immediate data transfer, including a request identifier in the form of a request number, an expiration date by which the request can be accepted and consented to, details of the recipient, details of the immediate data transfer and details of the recurring data transfer. The logical storage area selection interface 800 may further include a second selectable option 804 for indicating whether the intended transferor wishes to establish controls on the recurring data transfer. The remote device may transmit to the source system user input indicating the identification information of the logical storage area (e.g. a corresponding logical storage area identifier) that is selected.

Referring back to FIG. 6, in operation 614, upon receiving the user input from the remote device indicating the selection of a logical storage area and that the user wants to establish controls on the recurring data transfer, the source server may provide to the remote device a user interface for establishing one or more rule definitions. Specifically, a user of the remote device may input, configure or select a rule definition that is associated with the request for the immediate transfer, using the remote device. The rule definitions may be transmitted to the source system to be enforced against or imposed on the recurring data transfer specified in the request for the immediate data transfer. In other words, the rule definitions may specify criteria that should be satisfied by the recurring data transfer. If any of the rule definitions associated with the recurring data transfer are not satisfied, the source system may refuse the particular data transfer that violates the rule definitions.

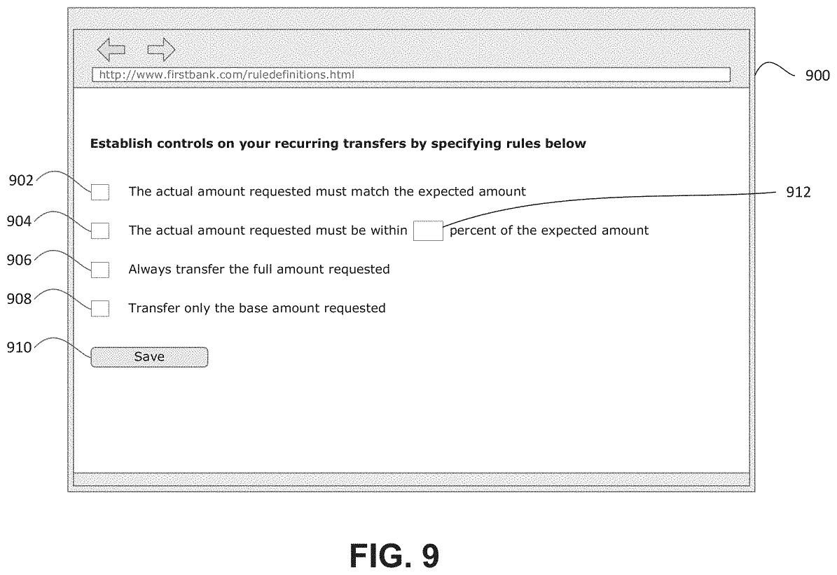

Referring briefly to FIG. 9, an example rule definitions interface 900 is illustrated.

The expected recurring amount that is specified in the request for the immediate data transfer may be the same as or different from an amount that is actually requested by the target system in the future. The rule definitions interface 900 provides a selectable option 902 for indicating the selection of a rule definition that requires that the actual amount requested match the expected recurring transfer amount specified in the request for the immediate data transfer.

The rule definitions interface 900 also provides a selectable option 904 for indicating the selection of a rule definition that requires the actual amount requested to be within a tolerance of the expected recurring transfer amount. As illustrated, the tolerance may be a percentage of the expected recurring transfer amount, but in at least some embodiments, the tolerance may be an absolute value. The rules definitions interface 900 includes a textbox 912 that may receive user input indicating a percentage value with which to configure the associated rule definition.

In some embodiments, a future request for a data transfer indicates a full amount, and a base amount and/or an overage amount. The full amount may be the sum of the base amount and the overage amount. In some cases, base amount is a fixed recurring amount and the overage amount is a variable amount and may be an unexpected amount. The base amount may represent a fixed portion of the full amount. The rule definitions interface 900 provides a selectable option 906 for indicating the selection of a rule definition that configures the source system to transfer the full amount requested. The rule definitions interface 900 also provides a selectable option 908 for indicating the selection of a rule definition that configures the source system to transfer only the base amount specified in the request. This may trigger the source system to transmit a notification to the remote device indicating the request for the overage amount. In response, the source system may receive user input from the remote device indicating authorization of a data transfer indicating the overage amount from the logical storage area associated with the transferor to the logical storage area associated with the recipient.

As illustrated, the selection of at least some of the selectable options 902, 904, 906 and 908 may be mutually exclusive. For instance, the selection of the selectable options 902 and 904 may be mutually exclusive.

It will be appreciated that any number of rule definitions may be provided for selection. The rule definitions may, for example, involve limits on the total amount transferred over a period of time (e.g. daily limits, weekly limits, monthly limits), constraints on a date a future data transaction may occur on (e.g. a recurring data transfer must always fall on a particular date), define a start and/or end date for the recurring data transfer, define the frequency of the recurring data transfer, and require the actual amount that is requested (e.g. an invoiced amount) is the same as the expected amount or within a tolerance (e.g. percentage) of the expected amount.

The rule definitions interface 900 also provides a selectable option 910 that may be invoked to transmit, to the source system for storage, the user input indicating the selection and configuration of one or more rule definitions.

Referring back to FIG. 6, in operation 616, the source server may provide to the remote device a user interface prompting the user to indicate their authorization of the immediate data transfer from the selected logical storage area associated with the intended transferor to the logical storage area associated with the recipient as specified in the request. The indication may further include an indication of consent of pre-authorization of the recurring data transfer from the logical storage area associated with the intended transferor to the logical storage area associated with the recipient as specified in the request and in accordance with any rule definitions established by the user of the remote device.

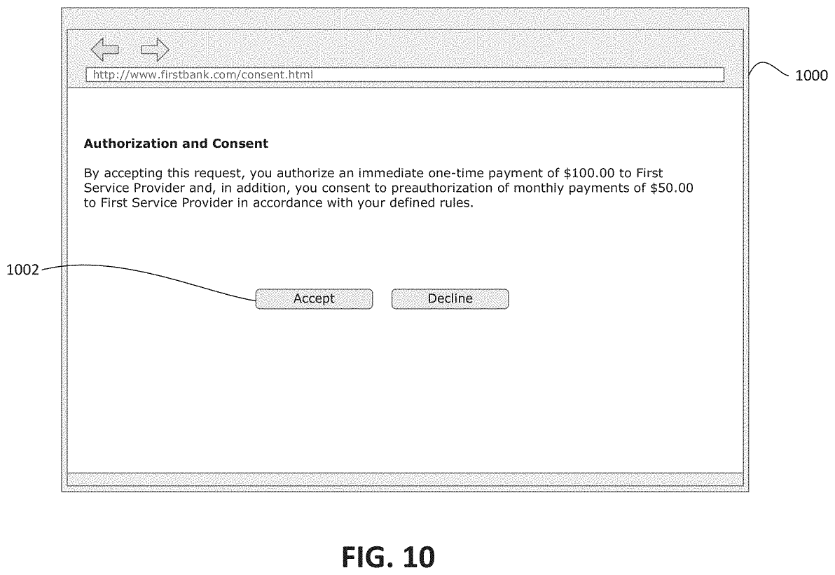

Referring briefly to FIG. 10, an example authorization interface 1000 is illustrated. The authorization interface 1000 prompts the user to provide their consent and includes a selectable option 1002 that may be activated to trigger the remote device to transmit to the source system user input indicating that the user consents.

Referring back to FIG. 6, in operation 618, in response to receiving the user input indicating authorization and consent, the source system may immediately transmit a message to the target system associated with the recipient. The message may transfer data indicating the requested transfer amount from the logical storage area associated with the intended transferor to the logical storage area associated with the recipient. The message may further include: the request identifier; an indication to the target system associated with the recipient of consent to pre-authorization of the recurring data transfer; and the rule definitions.

Once the target system receives this message, the configuration of the pre-authorization of the recurring data transfer may be considered to be complete and the recurring data transfer may be conducted.

In some cases, the source system is configured to initiate the recurring data transfer. In other words, the source system may configure a data transfer to occur on a date specified in metadata included in the request to configure the recurring data transfer and for a recurring transfer amount specified in the metadata. In some embodiments, the rule definitions and/or the metadata may indicate to the source system: the transfer amount to be pushed to the target system in each cycle (i.e. particular data transfer) of the recurring data transfer; the start date for the recurring data transfer; and the frequency of the recurring data transfer. In this way, the recurring transfer amount may be pushed from the logical storage area associated with the transferor to the logical storage area associated with the recipient without the transferor sharing identification information or details of their logical storage area with the target system (e.g. a logical storage area identifier).

If the transfer amount that is pushed to target system is insufficient, then the target system may transmit to the source system a request for an overage data transfer. The request for an overage data transfer may include an overage transfer amount that is associated with an actual usage amount exceeding an expected usage amount. For example, the overage transfer amount may be based on a monthly usage of an internet service exceeding a threshold for a particular month.

In response to the request for the overage data transfer, the source system may transmit a notification to the remote device indicating the receipt of the request for the overage data transfer the request indicating a requested overage transfer amount. In response, the source system may receive user input from the remote device indicating authorization of the requested overage data transfer. In this way, the source system may receive, on a date specified in the metadata or the rule definitions, a request to transfer data, the request to transfer data indicating an overage transfer amount associated with an actual usage amount exceeding an expected usage amount.

In some cases, the target system is configured to initiate the recurring data transfer. In this case, the message in operation 618 of FIG. 6 may include: a logical storage area identifier associated with the transferor and to be used by the target system associated with the recipient to conduct the recurring data transfer; and identification information of the source system and the entity operating, managing or otherwise associated with the target system (e.g. a financial institution identifier, routing number, branch transit number). The rule definitions and/or the details of the request to configure the recurring data transfer may indicate to the target system: the transfer amount to be pulled from the source system in each cycle of the recurring data transfer; the start date for the recurring data transfer; and the frequency of the recurring data transfer. In this way, the recurring transfer amount may be pulled from the logical storage area associated with the transferor to the logical storage area associated with the recipient. The target system may also use the rule definitions to validate each cycle of the recurring data transfer to ensure that the target system does not violate the rule definitions. If the target system determines that a particular data transfer would violate rule definitions, then the target system may suppress the data transfer and use an alternative technique for requesting a data transfer. When the source system receives a data transfer in a cycle of the recurring data transfer, the source system may enforce the rules definitions to ensure that the data transfer complies with the rule definitions.

In some embodiments, the request for the immediate data transfer and the rule definitions may contain valuable information regarding future data transfers. In the case where the data transfers relate to financial instruments and monetary amounts, the request and rule definitions may be useful in enhancing the accuracy of cash flow tools provided by the source system and target system. For example, the source system may analyze the request and rule definitions to generate a prediction the cash flow of the transferor, including cash inflows and outflows, over a specific period of time. Similarly, the target system may analyze the request and rule definitions to generate a prediction the cash flow of the recipient, including cash inflows and outflows, over a specific period of time.

It will be appreciated that the method 600 of FIG. 6 as described may be modified. In particular, the overlay system may, in at least some embodiments and some cases, transmit the notification to the source system rather than to the remote device. In this case, the overlay system may store a directory of aliases that map to respective entities associated with respective source systems, and in some embodiments, may also map to respective default logical storage area identifiers. The directory may be used by the overlay system to send the notification to the entity associated with the transferor. For instance, an alias may be an email address associated with the transferor that maps to an identifier of a financial institution at which the transferor is a customer. When the overlay system receives a request for an immediate data transfer from a target system, the overlay system may retrieve the intended transferor's email address from the request and use that alias to lookup the transferor's financial institution in the directory and, in some embodiments, the default logical storage area identifier associated with the alias. The overlay system may then transmit the request for the immediate data transfer to the source system associated with that financial institution. The transmission may include the identification information of the default logical storage area. In other words, the overlay system may transmit the request and default logical storage area identifier to the source system that is associated with the entity that is identified through the directory.

Upon receiving the request from the overlay system, the source system may engage the remote device using the alias that is specified in the request for the immediate data transfer. In some embodiments, the source system may send a notification of the request to a remote device that is associated with the alias that is specified in the request (for example, via an email or text message), or to a remote device that is associated with the user account associated with the alias.

In some embodiments, the remote device may present the notification in a notification interface provided by the source system. In some embodiments, the notification may be transmitted to an application installed on the remote device. The application may be associated with the source system and may be provided by the entity associated with the source system. The notification may be presented in a notification interface of the application.

The notification interface may, in at least some embodiments, be presented by the remote device after the remote device has successfully authenticated itself as being associated with a particular user account in the source system using a credential (e.g., username/password, biometric data, etc.). That is, the remote device uses a credential to confirm that it is associated with a particular account-holder.

In some embodiments, the source system may use the default logical storage area identifier to preselect the default logical storage area in the logical storage area selection interface. Those skilled in the art will recognize that other variations may be necessary.

It will be further appreciated that in some embodiments the overlay system may not be separate from the target system and at least some aspects of the overlay system may be integrated into the target system. In such embodiments, the methods and operations described herein may be modified. For example, the target system may not transmit the request to the overlay system in operation 602 in the method 600 of FIG. 6, but may perform at least some aspects of the operation 604 in the method 600 of FIG. 6. In particular, the target system may transmit the notification to the remote device. As another example, the target system may transmit the notification or the request to the source system. Those skilled in the art will recognize that other variations may be necessary.

It will be further appreciated that it may be that some or all of the above-described operations of the various above-described example methods may be performed in orders other than those illustrated and/or may be performed concurrently without varying the overall operation of those methods.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a communications module;
a processor coupled to the communications module; and
a memory coupled to the processor storing instructions that, when executed by the computer system, cause the computer system to:
receive, from a first computing system, a request to configure a recurring data transfer to a recipient, the request provided as a request for an immediate data transfer, the request for the immediate data transfer indicating a requested transfer amount and an intended transferor, the intended transferor indicated using an alias;
receive user input from a computing device distinct from the first computing system and engaged using the alias, the user input including an indication of authorization of the immediate data transfer from a logical storage area associated with the intended transferor, the indication further including an indication of consent to pre-authorization of the recurring data transfer from the logical storage area associated with the intended transferor; and
in response to receiving the user input, transmit a message to a system associated with the recipient, the message transferring data indicating the requested transfer amount from the logical storage area associated with the intended transferor, and wherein the message further includes an indication to the system associated with the recipient of consent to pre-authorization of the recurring data transfer.

2. The computer system of claim 1, wherein the instructions further cause the computer system to:
configure a data transfer to occur on a date specified in metadata included in the request to configure the recurring data transfer and for a recurring transfer amount specified in the metadata.

3. The computer system of claim 2, wherein the requested transfer amount is different from the recurring transfer amount.

4. The computer system of claim 1, wherein the instructions further cause the computer system to, in response to receiving the user input from the computing device:
transmit, to the system associated with the recipient, a logical storage area identifier to be used to conduct the recurring data transfer.

5. The computer system of claim 1, wherein the instructions further cause the computer system to:
receive user input from the computing device indicating rule definitions;
transmit the rule definitions to the system associated with the recipient; and
enforce the rule definitions.

6. The computer system of claim 1, wherein the first computing system maps the alias to a financial institution.

7. The computer system of claim 1, wherein the request to configure the recurring data transfer is received in response to user activation of an email or text message that prompts the computer system to retrieve the request for the immediate data transfer from the first computing system.

8. The computer system of claim 2, wherein the instructions further cause the computer system to:
receive, on the date specified in the metadata, a request to transfer data, the request to transfer data indicating an overage transfer amount associated with an actual usage amount exceeding an expected usage amount.

9. The computer system of claim 1, wherein the requested transfer amount is nominal or zero.

10. The computer system of claim 2, wherein the indication of authorization of the immediate data transfer from the logical storage area associated with the intended transferor further includes an indication of authorization of the immediate data transfer from the logical storage area associated with the intended transferor to a logical storage area associated with the recipient.

11. A method comprising:
receiving, via a communications module and from a first computing system, a request to configure a recurring data transfer to a recipient, the request provided as a request for an immediate data transfer, the request for the immediate data transfer indicating a requested transfer amount and an intended transferor, the intended transferor indicated using an alias;
receiving, via the communications module, user input from a computing device distinct from the first computing system and engaged using the alias, the user input including an indication of authorization of the immediate data transfer from a logical storage area associated with the intended transferor, the indication further including an indication of consent to pre-authorization of the recurring data transfer from the logical storage area associated with the intended transferor; and
in response to receiving the user input, transmitting a message to a system associated with the recipient, the message transferring data indicating the requested transfer amount from the logical storage area associated with the intended transferor, and wherein the message further includes an indication to the system associated with the recipient of consent to pre-authorization of the recurring data transfer.

12. The method claim 11, further comprising:
configuring a data transfer to occur on a date specified in metadata included in the request to configure the recurring data transfer and for a recurring transfer amount specified in the metadata.

13. The method of claim 11, wherein the requested transfer amount is different from the recurring transfer amount.

14. The method of claim 11, further comprising, in response to receiving the user input from the computing device:
transmitting, to the system associated with the recipient, a logical storage area identifier to be used to conduct the recurring data transfer.

15. The method of claim 11, further comprising:
receiving user input from the computing device indicating rule definitions;
transmitting the rule definitions to the system associated with the recipient; and
enforcing the rule definitions.

16. The method of claim 11, wherein the first computing system maps the alias to a financial institution.

17. The method of claim 11, wherein the request to configure the recurring data transfer is received in response to user activation of an email or text message that prompts retrieving the request for the immediate data transfer from the first computing system.

18. The method of claim 12, further comprising:
receiving, on the date specified in the metadata, a request to transfer data, the request to transfer data indicating an overage transfer amount associated with an actual usage amount exceeding an expected usage amount.

19. The method of claim 11, wherein the requested transfer amount is nominal or zero.

20. A non-transitory computer-readable storage medium comprising processor-executable instructions which, when executed, configure a processor to:
receive, from a first computing system, a request to configure a recurring data transfer to a recipient, the request provided as a request for an immediate data transfer, the request for the immediate data transfer indicating a requested transfer amount and an intended transferor, the intended transferor indicated using an alias;
receive user input from a computing device distinct from the first computing system and engaged using the alias, the user input including an indication of authorization of the immediate data transfer from a logical storage area associated with the intended transferor, the indication further including an indication of consent to pre-authorization of the recurring data transfer from the logical storage area associated with the intended transferor; and
in response to receiving the user input, transmit a message to a system associated with the recipient, the message transferring data indicating the requested transfer amount from the logical storage area associated with the intended transferor, and wherein the message further includes an indication to the system associated with the recipient of consent to pre-authorization of the recurring data transfer.
